(19) United States
(12) Patent Application Publication
(10) Pub. No.: US 2005/0110401 A1
(43) Pub. Date: May 26, 2005

(54) Light emitting diode package structure

(76) Inventor: Jung Kan Lin, Gueishan Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/720,526

(22) Filed: Nov. 25, 2003

(51) Int. Cl. H05B 33/04

(52) U.S. Cl. 313/512; 428/68; 428/76; 428/690; 428/917; 257/100

(57) ABSTRACT

A LED package structure includes a substrate, a light emitting diode die located on the substrate, and a phosphoric medium layer located on the substrate and covered the light emitting diode die. The phosphoric medium layer has a package mold precipitated a phosphor sediment layer on bottom and the phosphor sediment layer tightly covers the light emitting diode die to reduce the light-color leakage rate of the LED.

### BACKGROUND OF INVENTION

1. Field of the Invention

The invention relates to a package technology of a light emitting diode (LED), and more particularly, to a white-light LED package structure.

2. Description of the Prior Art

In general, a LED package structure is achieved by using transfer molding method or liquid-glue encapsulating method. While manufacturing the white-light LED package structure, the materials for the two methods are solid phosphoric epoxy resin and liquid phosphoric epoxy resin respectively. No matter what method is used, the package structure of both methods is the same as shown in FIG. 1. A LED die 12 is located on a substrate 10 and is covered with a mixture layer 14 composed of phosphor and epoxy resin. The phosphor powder 16 is dispersed in the epoxy resin 18 without concentrating on the LED die 12, so the LED die 12 has a higher light-color leakage rate.

Hence, the present invention provides a LED package structure to solve the disadvantage of high light-color leakage rate.

### SUMMARY OF INVENTION

It is therefore a primary objective of the claimed invention to provide a LED package structure in which the phosphor powder of the phosphoric glue is precipitated over the LED die to effectively reduce the light-color leakage rate of the LED.

According to the claimed invention, a LED package structure includes a substrate, a light emitting diode die located on the substrate, and a phosphoric medium layer located on the substrate and covered the light emitting diode die. The phosphoric medium layer includes a package mold precipitated a phosphor sediment layer on bottom. The phosphor sediment layer tightly covers the light emitting diode die to reduce the light-color leakage rate of the LED.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a cross-sectional diagram of a white-light LED package structure according to prior art.

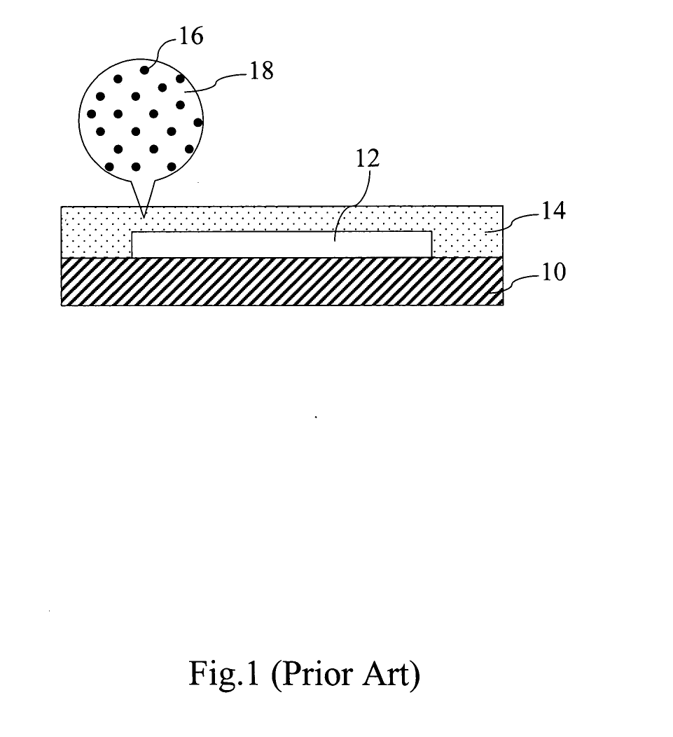

FIG. 2 is a cross-sectional diagram of a LED package structure according to present invention.

FIG. 3 is a partial magnified diagram of FIG. 2.

### DETAILED DESCRIPTION

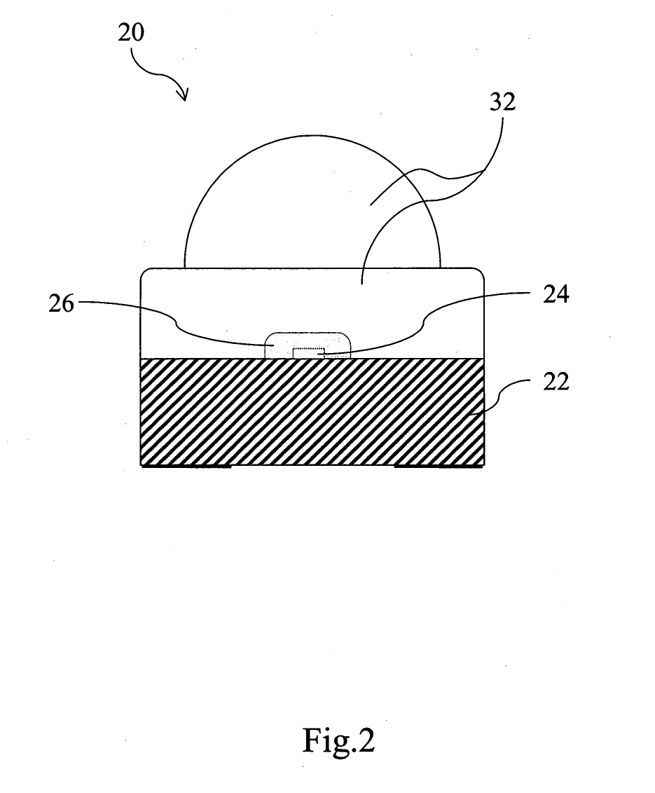

Please refer to FIG. 2, which is a cross-sectional diagram of a LED package structure according to present invention. A LED package structure 20 comprises a substrate 22, the substrate 22 is generally a printed circuit board (PCB) or a metal frame, and a LED unit is equipped on the substrate 22. The LED unit is a LED die 24 located on the substrate 22 and covered with a phosphoric medium layer 26. An outer package mold 32, which is generally a epoxy resin, covers the phosphoric medium layer 26.

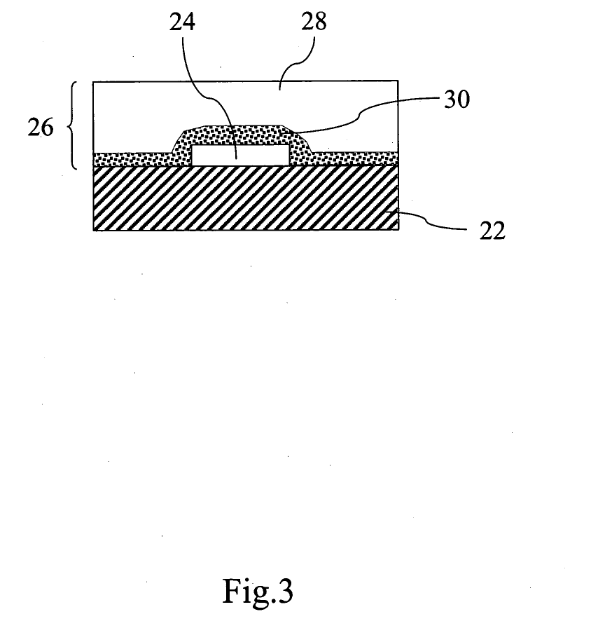

Please refer to FIG. 3, which is a partial magnified diagram of FIG. 2. The phosphoric medium layer 26 comprises a package mold 28, and a phosphor sediment layer 30 is precipitated on bottom of the package mold 28 to tightly cover the light emitting diode die 24. Material of the package mold 28 is generally the epoxy resin, and the phosphor sediment layer 30 is composed of the phosphor powders. The phosphor powders and the frequency-fixed LED can refract each other to emit white light.

For forming this package structure, the casting mold method can be utilized. The raw material is liquid phosphoric glue that is uniformly mixed by phosphor powders and package mold. When proceeding the casting mold method, make the liquid phosphoric glue saturated, and the phosphor powders are precipitated on the LED die and tightly cover it. And the structure is formed as shown in FIG. 3.

In contrast to the prior art, the present invention precipitates the phosphor powders on bottom of the package mold can tightly cover the phosphor powders on the LED die, so that the light-color leakage rate of LED can be effectively reduced.

Those skilled in the art will readily observe that numerous modifications and alterations of the device may be made while retaining the teachings of the invention. Accordingly, the above disclosure should be construed as limited only by the metes and bounds of the appended claims.

1. A light emitting diode (LED) package structure, comprising:
a substrate;
a light emitting diode die located on the substrate; and
a phosphoric medium layer located on the substrate and covered the light emitting diode die, wherein the phosphoric medium layer comprises a package mold precipitated a phosphor sediment layer on bottom and the phosphor sediment layer tightly covers the light emitting diode die.

2. The LED package structure of claim 1 wherein the package mold is an epoxy resin.

3. The LED package structure of claim 1 wherein the phosphor sediment layer is composed of phosphor powders.

4. The LED package structure of claim 1 wherein the phosphoric medium layer is formed on the substrate by a casting mold.

5. The LED package structure of claim 1 emits white light.

6. The LED package structure of claim 1 wherein the phosphoric medium layer further covered by an outer package mold.

7. The LED package structure of claim 6 wherein the outer package mold is formed on the substrate by a casting mold.

8. The LED package structure of claim 6 wherein the outer package mold is an epoxy resin.

9. The LED package structure of claim 1 wherein the substrate is a printed circuit board.
